(19) United States
(12) Patent Application Publication
(10) Pub. No.: US 2019/0362366 A1
(43) Pub. Date: Nov. 28, 2019

(54) PAYMENT TERMINAL MONITORING SYSTEM AND PAYMENT TERMINAL MONITORING METHOD

(71) Applicant: NUVENT.INC, Seoul (KR)

(72) Inventors: Chun Sik KIM, Yongin-si (KR); Sung Jin YOON, Yongin-si (KR); So Youn HAN, Seoul (KR); Geun Tae KIM, Seoul (KR); Sung Joon KIM, Hwaseong-si (KR); Yong Hyung LEE, Suwon-si (KR)

(21) Appl. No.: 16/181,875

(22) Filed: Nov. 6, 2018

Related U.S. Application Data
(63) Continuation of application No. PCT/KR2018/012758, filed on Oct. 25, 2018.

(30) Foreign Application Priority Data
May 23, 2018 (KR) 10-2018-0058542

(51) Int. Cl. G06Q 30/02; G06Q 20/20

(52) U.S. Cl. CPC G06Q 30/0201; G06Q 20/202

(57) ABSTRACT

A payment terminal monitoring device includes: a communication unit which receives payment information generated in a payment terminal for each store; a detecting unit which detects status information of the payment terminal for each store; and a situation analyzing unit which classifies a store situation for each category, based on the payment information for each store, store information, and the status information and determines a store risk level.

### BACKGROUND

### Technical Field

The present disclosure relates to a payment terminal monitoring system and a payment terminal monitoring method.

### Description of the Related Art

In the case of self-employed persons, loans are frequently made for business start-ups. In the case of banks or lenders that provide loans to self-employed persons, it is necessary to constantly manage whether the self-employed persons or debtors can repay the loan. However, in the related art, the banks or lenders directly visit the stores of the debtors to check the business situation, which is very inefficient and unable to monitor the business situation in real time.

Further, when the sales of the debtor's store are reduced and the business is not smoothly operated, it is necessary to check and respond to the reduced sales and the business situation early. However, a level of development of a technology which is capable of monitoring a plurality of stores in real time is inadequate.

In the meantime, separately from the loan management of the above-mentioned financial service provider, the self-employed persons or managers (for example, a head office of franchise) of individual stores need to consistently monitor a business situation of each store, sales information, menu management, and whether the business is smoothly operated, in real time. However, until now, only limited information has been obtained due to information passively provided by individual stores and obtained by directly visiting the individual stores offline.

A related art of the present disclosure is disclosed in Korean Unexamined Patent Application Publication No. 2017-0096463.

### SUMMARY

An object to be achieved by the present disclosure is to provide a payment terminal monitoring system and a payment terminal monitoring method which are capable of monitoring sales statuses of stores in real time.

Another object to be achieved by the present disclosure is to provide a payment terminal monitoring system and a payment terminal monitoring method which are capable of determining a risk state of business or sales of the store in accordance with the sales and business situation of the store.

Another object to be achieved by the present disclosure is to provide a payment terminal monitoring system and a payment terminal monitoring method which provide an optimal route to visit stores to be managed.

However, objects to be achieved by various exemplary embodiments of the present invention are not limited to the technical objects as described above and other technical objects may be present.

According to an aspect of the present disclosure, a payment terminal monitoring device includes a communication unit which receives payment information generated in a payment terminal for each store, a detecting unit which detects status information of the payment terminal for each store, and a situation analyzing unit which classifies a store situation for each category, based on the payment information for each store, store information, and the status information.

According to an exemplary embodiment of the present disclosure, the payment terminal monitoring device may further include an information generating unit which generates sales status information for each store, based on the payment information and the store information and the payment information may include a payment menu, a payment price, a payment time, and a payment terminal identifier and the store information may include at least one of business hour information of the store, closing hour information, and store location information.

According to an exemplary embodiment of the present disclosure, the communication unit may transmit the sales status information, the store situation for each category, and information on the store risk level to a user terminal.

According to an exemplary embodiment of the present disclosure, the store situation for every category may include categories indicating all stores, a store with normal sales, a sales warning store, a store where a payment terminal is not driven, and a waiting store.

According to an exemplary embodiment of the present disclosure, the store risk level may include a risk level of a category of the sales warning store and the store where a payment terminal is not driven and when the communication unit does not receive the payment information from the store during the business hour of the store, the detecting unit may detect the status information indicating that the payment terminal of the store is not driven, based on the business hour information and closing hour information of the store.

According to an exemplary embodiment of the present disclosure, the situation analyzing unit may classify a store from which payment information has never received from a store corresponding to previously stored store information as a waiting store.

According to an exemplary embodiment of the present disclosure, the payment terminal monitoring device may further include: a display unit which generates identifier information displayed on a map, based on the store information for each category of the store situation for each category and the communication unit may transmit the identifier information to the user terminal.

According to an exemplary embodiment of the present disclosure, the display unit may generate the identifier information such that at least one of a shape, a size, and a color of the identifier varies depending on categories of the store situation for each category and at least one of a shape, a size, and a color of the identifier varies depending on the risk level of the store.

According to an exemplary embodiment of the present disclosure, the display unit may generate travel route information between at least two stores among a plurality of stores classified as sales warning stores or a store where a payment terminal is not driven and the communication unit may transmit the travel route information to the user terminal.

According to another aspect of the present disclosure, a user terminal which monitors a payment terminal of a store includes: a terminal communication unit which receives payment information generated by a payment terminal for each store and status information of the payment terminal for each store, from a payment terminal monitoring device; and an output unit which outputs a store situation for each category classified based on the payment information for each store, store information, and the status information and a store risk level.

According to an exemplary embodiment of the present disclosure, the terminal communication unit may receive sales status information for each store generated based on the payment information and the store information from the payment terminal monitoring device and the payment information may include a payment menu, a payment price, a payment time, and a payment terminal identifier and the store information may include at least one of business hour information of the store, closing hour information, and store location information.

According to an exemplary embodiment of the present disclosure, the terminal communication unit may receive the information on the store situation for each category and the store risk level from the payment terminal monitoring device.

According to an exemplary embodiment of the present disclosure, the store situation for each category may include categories indicating all stores, a store with normal sales, a sales warning store, a store where a payment terminal is not driven, and a waiting store.

According to an exemplary embodiment of the present disclosure, the store risk level may include a risk level of a category of the sales warning store and the store where a payment terminal is not driven.

According to an exemplary embodiment of the present disclosure, the terminal communication unit may receive identifier information displayed on a map, based on the store information for each category of the store situation for each category from the payment terminal monitoring device.

According to an exemplary embodiment of the present disclosure, in the identifier information, at least one of a shape, a size, and a color of the identifier varies depending on categories of the store situation for each category and at least one of a shape, a size, and a color of the identifier varies depending on the risk level of the store.

According to an exemplary embodiment of the present disclosure, the output unit outputs an identifier displayed on the map based on the identifier information.

According to an exemplary embodiment of the present disclosure, the terminal communication unit receives travel route information between at least two stores among a plurality of stores which are classified as a sales warning store and a store where the payment terminal is not driven, from the payment terminal monitoring device.

According to still another aspect of the present disclosure, a payment terminal monitoring method of a store includes: receiving payment information generated in a payment terminal for each store, detecting status information of the payment terminal for each store, and classifying a store situation for each category based on the payment information for each store, store information, and the status information and determining a store risk level.

According to an exemplary embodiment of the present disclosure, the payment terminal monitoring method may further include: generating sales status information for each store, based on the payment information and the store information and the payment information may include a payment menu, a payment price, a payment time, and a payment terminal identifier and the store information may include at least one of business hour information of the store, closing hour information, and store location information.

According to an exemplary embodiment of the present disclosure, the sales status information, the store situation for each category, and information on the store risk level may be transmitted to a user terminal.

According to an exemplary embodiment of the present disclosure, the store situation for each category may include categories indicating all stores, a store with normal sales, a sales warning store, a store where a payment terminal is not driven, and a waiting store.

According to an exemplary embodiment of the present disclosure, the store risk level may include a risk level of a category of the sales warning store and the store where a payment terminal is not driven and when the communication unit does not receive the payment information from the store during the business hour of the store, in the detecting of status information, the status information indicating that the payment terminal of the store is not driven, based on the business hour information and closing hour information of the store may be detected.

According to an exemplary embodiment of the present disclosure, during the classifying of a store situation for each category and determining of a store risk level, a store from which payment information has never received from a store corresponding to previously stored store information may be classified as a waiting store.

According to an exemplary embodiment of the present disclosure, the payment terminal monitoring method may further include: generating identifier information displayed on a map, based on the store information for each category of the store situation for each category and during the transmitting to a user terminal, the identifier information may be transmitted to the user terminal.

According to an exemplary embodiment of the present disclosure, during the generating of identifier information, the identifier information is generated such that at least one of a shape, a size, and a color of the identifier varies depending on categories of the store situation for each category and at least one of a shape, a size, and a color of the identifier varies depending on the risk level of the store.

According to an exemplary embodiment of the present disclosure, during the generating of identifier information, travel route information between a plurality of stores classified as sales warning stores or a store where a payment terminal is not driven may be generated and during the transmitting to a user terminal, the travel route information may be transmitted to the user terminal.

The above-described solving means are merely illustrative but should not be construed as limiting the present disclosure. In addition to the above-described exemplary embodiments, additional exemplary embodiments may be further provided in the drawings and the detailed description of the present disclosure.

According to the present disclosure, a payment terminal monitoring system and a payment terminal monitoring method which are capable of monitoring the sales status of the store in real time may be provided.

According to the present disclosure, a payment terminal monitoring system and a payment terminal monitoring method which are capable of determining a risk state in accordance with the sales and the business situation of the store may be provided.

According to the present disclosure, a payment terminal monitoring system and a payment terminal monitoring method which are capable of providing an optimal route to visit stores to be managed may be provided.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view illustrating a configuration of a payment terminal monitoring system of a store according to an exemplary embodiment of the present disclosure;

FIG. 2 is a view illustrating a configuration of a payment terminal monitoring device according to an exemplary embodiment of the present disclosure;

FIG. 3 is a view illustrating a configuration of a user terminal of a payment terminal monitoring system according to an exemplary embodiment of the present disclosure;

FIG. 4 is a view illustrating a store situation and a risk level for each category output on a user terminal of a payment terminal monitoring system according to an exemplary embodiment of the present disclosure;

FIG. 5 is a view illustrating a situation of a sales warning store output on a user terminal of a payment terminal monitoring system according to an exemplary embodiment of the present disclosure;

FIG. 6 is a view illustrating a situation of a store where a payment terminal is not driven output on a user terminal of a payment terminal monitoring system according to an exemplary embodiment of the present disclosure;

FIG. 7 is a view illustrating a situation of a waiting store output on a user terminal of a payment terminal monitoring system according to an exemplary embodiment of the present disclosure;

FIG. 8 is a view illustrating a map and an identifier output on a user terminal of a payment terminal monitoring system according to an exemplary embodiment of the present disclosure; and

FIG. 9 is a view illustrating a message notifying a store situation for each category output on a user terminal of a payment terminal monitoring system according to an exemplary embodiment of the present disclosure.

FIG. 10 is a flowchart illustrating a payment terminal monitoring method according to an exemplary embodiment of the present disclosure.

### DETAILED DESCRIPTION OF THE EMBODIMENT

Hereinafter, the present disclosure will be described more fully with reference to the accompanying drawings, in which exemplary embodiments of the present disclosure are shown. However, the present disclosure can be realized in various different forms, and is not limited to the exemplary embodiments described herein. Accordingly, in order to clearly explain the present disclosure in the drawings, portions not related to the description are omitted. Like reference numerals designate like elements throughout the specification.

Throughout this specification and the claims that follow, when it is described that an element is “coupled” to another element, the element may be “directly coupled” to the other element or “electrically coupled” to the other element through a third element.

Through the specification of the present disclosure, when one member is located “on”, “above”, “on an upper portion”, “below”, “under”, and “on a lower portion” of the other member, the member may be adjacent to the other member or a third member may be disposed between the above two members.

In the specification, unless explicitly described to the contrary, the word “comprise” and variations such as “comprises” or “comprising”, will be understood to imply the inclusion of stated elements but not the exclusion of any other elements.

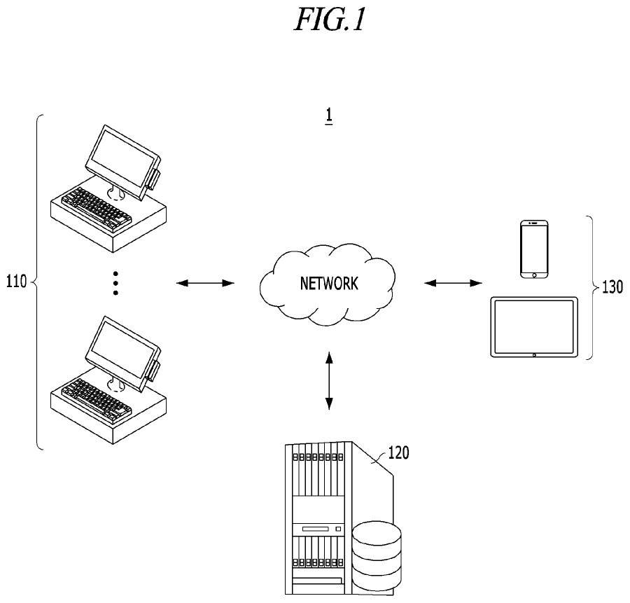

FIG. 1 is a view illustrating a configuration of a payment terminal monitoring system of a store according to an exemplary embodiment of the present disclosure.

Referring to FIG. 1, a payment terminal monitoring system 1 of a store according to an exemplary embodiment of the present disclosure may include a payment terminal 110, a payment terminal monitoring device 120, and a user terminal 130. A plurality of payment terminals 110 and a plurality of user terminals 130 may be provided. Components of the payment terminal monitoring system 1 of the store may be generally connected to each other via a network. The network means a connection structure which allows information exchange between nodes such as terminals or servers and examples of the network include 3^{rd} generation partnership project (3GPP) network, a long term evolution network (LTE), a 5G network, a world interoperability for microwave access (WIMAX) network, Internet, a local area network (LAN), a wireless local area network (wireless LAN), a wide area network (WAN), a personal area network (PAN), a wifi network, a Bluetooth network, a satellite broadcasting network, an analog broadcasting network, and a digital multimedia broadcasting (DMB) network, but are not limited thereto.

The payment terminal 110 may be equipped in each store or franchisee, for example, may be a point of sale (POS) terminal. When a purchaser is requested to make a payment for a product or a service, the payment terminal 110 simultaneously performs the payment process and generates payment information based on signal information which is output to a receipt. Further, according to an exemplary embodiment of the present disclosure, the payment information may include a payment menu, a payment price, a payment time, and a payment terminal identifier (POS ID). The payment terminal 110 may transmit payment information generated in accordance with the payment to the payment terminal monitoring device 120.

The payment terminal monitoring device 120 may generate sales status information based on the payment information received from the payment terminal 110 and previously stored store information. For example, the store information may include at least one of a store identifier (franchisee ID), business hour information of the store, closing hour information, and store location information. The store information may be received by the payment terminal monitoring device 120 to be stored in advance in accordance with the input of a user or a manager of the payment terminal 110. The payment terminal monitoring device 120 matches the store ID and the identifier of the payment terminal 110 to detect a store where the payment is processed and analyzes and generates sales status information for each store based on the store information for the detected store and the payment information. The sales status information may be entire sales information including the business hour and the closing hour of the store for each store included in the store information and the payment menu and the payment price included in the payment information. Further, the payment terminal monitoring device 120 may calculate cumulative sales based on the sales status information. The cumulative sales may refer to sales accumulated from a predetermined reference time (for example, a time when the store subscribes to a service provided through the payment terminal monitoring device of the present disclosure) to the present time.

Further, according to an exemplary embodiment of the present disclosure, the payment terminal monitoring device 120 may detect status information of the payment terminal 110 for each store. The status information, for example, may include information on a driving status or non-driving status of the payment terminal 110. For example, the payment terminal monitoring device 120 may periodically transmit a payment terminal driving signal to the payment terminal 110 for each store. When the payment terminal driving signal is received, if the payment terminal 110 is being driven, the payment terminal 110 may transmit an answer signal to the payment terminal monitoring device 120. The payment terminal monitoring device 120 may determine that the payment terminal 110 which transmits (replies) the answer signal is in a driving state and a store equipped with the payment terminal 110 is being operated. Further, as another example, when the payment terminal monitoring device 120 does not receive payment information (or the answer signal) even in the business hour of the store, based on the business hour information and the closing hour information of the store, the payment terminal monitoring device 120 may detect status information indicating that the payment terminal 110 is not driven.

Even though the payment information or the answer signal is not received from the payment terminal 110 of the store during the closing hour of the store or besides the business hour, the payment terminal monitoring device 120 does not determine that the payment terminal 110 is not driven. However, when the payment information or the answer signal is not received during the business hour, the payment terminal monitoring device 120 may detect status information indicating that the payment terminal 110 of the store is not driven.

According to an exemplary embodiment of the present disclosure, the payment terminal monitoring device 120 divides the store situation for each category based on the payment information, the store information, and the situation information received from each payment terminal 110 and determines a risk level of the store. The store situation for each category indicates a plurality of categories set to check the business status of the store based on the sales status and status information for every store described above and a store corresponding to the individual category. The store situation for each category may include categories indicating “all stores”, “a store with normal sales”, “a sales warning store”, “a store where a payment terminal is not driven”, and “a waiting store.” It is determined whether an arbitrary store corresponds to any one of “all stores”, “a store with normal sales”, “a sales warning store”, “a store where a payment terminal is not driven”, and “a waiting store” by information received from the payment terminal 110 of the store and the store may be a store where the payment terminal 110 is installed.

According to an exemplary embodiment of the present disclosure, “all stores” mean information of all stores which use a service provided through the payment terminal monitoring device 120 of the present disclosure and the number of stores. Further, the “store with normal sales” refers to a store that a difference between a sales average of previous reference day and a sales average of a recent reference day is smaller than a predetermined threshold value. The previous reference day may be a range of past dates set by the user's selection, such as the previous month, six months ago, or a year ago. Further, the recent reference day may be a week or a month including a calculation date of the store situation for each category or a calculated date. That is, the recent reference day may also be a range of the recent dates set by the user's selection.

Further, the “sales warning store” may be a store where a difference between the average sales of the past business days and the average sales of the recent business days is equal to or higher than a predetermined threshold value. For example, the categories of the store with normal sales and the sales warning store will be described. When the past reference days are 30 days and the recent reference day is yesterday, a store may be classified as a store with normal sales or a sales warning store depending on the result of comparing the average sales for 30 days and the sales of yesterday, for example, a difference or a rate of change.

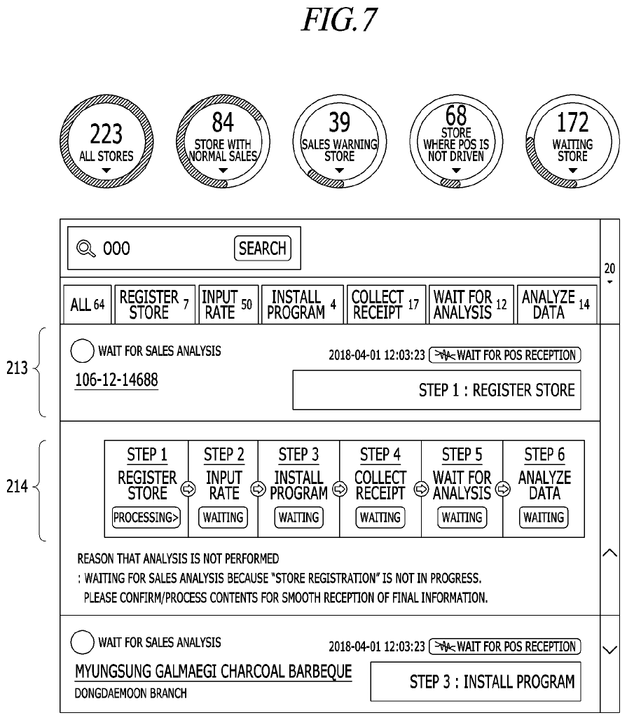

The “store where the payment terminal is not driven” indicates a store where the un-driven time of the payment terminal 110 is equal to or higher than a predetermined threshold time. Information indicating that the payment terminal 110 is not driven and when it has not been driven may be determined when the payment terminal monitoring device 120 fails to receive an answer for the payment terminal driving signal or the payment information from the payment terminal 110. The “waiting store” indicates a store which has never received payment information from a store corresponding to store information previously stored in the terminal monitoring device 120. That is, the waiting store means a store which has subscribed to use a service provided by the payment terminal monitoring device 120 of the present disclosure but has not completed an administrative process required to receive a formal service. A processing process of the waiting store will be described below with reference to FIG. 7.

A store risk level determined by the payment terminal monitoring device 120 may include a risk level having categories such as “a sales warning store” and “a store where a payment terminal is not driven.” The payment terminal monitoring device 120 may determine a sales risk step of the store depending on how much the difference between the average sales of the past reference date and the average sales of the recent business days is higher than the predetermined threshold value. The past reference date or the recent business days may be set in advance by a user or the payment terminal monitoring device 120 and may be set to have various values such as one day, three days, or seven days. Further, for example, when the difference between the average sales of the past reference date of the store and the average sales of the recent reference date is equal to or higher than a first threshold value, it is determined that the store is in a first sales risk level. When the difference between the average sales of the past reference date and the average sales of the recent reference date is equal to or higher than a second threshold value, it is determined that the store is in a second sales risk level. The second threshold value may be larger than the first threshold value. Further, according to an exemplary embodiment, the risk level may also be divided into a third risk level or a fourth risk level in accordance with a third threshold value and a fourth threshold value. The service provided through the payment terminal monitoring device 120 of the present disclosure may be utilized for a manager of a bank or a lender which provides the loan to the entrepreneur for a business start-up to easily manage a store which uses a loan. The manager needs to periodically and actually monitor whether the store which uses a loan is capable of repaying. Therefore, the manager may easily identify a store which is in a risk level by assigning a risk level depending on the sales. Specifically, in the case of a store to which a second risk level is assigned, information on the store may be provided to be intensively managed.

Further, the payment terminal monitoring device 120 may determine a business risk level depending on a time during which the payment terminal 110 of the store is not driven. For example, when the un-driven time of the payment terminal 110 is equal to or larger than the first threshold time, the store is determined to be in a first business risk level and when the un-driven time of the payment terminal of the store is equal to or larger than the second threshold time, the store may be determined to be in the second business risk level. The second threshold time may be longer than the first threshold time. In the case of the store where the payment terminal is not driven, the store does not transmit the payment information even during the business hour or the payment terminal 110 of the store is not driven, that is, the power is not turned off so that the store may be a target to be managed by the manager. Therefore, the stores which are in the business risk level are classified so that information on the store where the payment terminal is not driven may be provided to easily identify the corresponding store.

Further, according to the exemplary embodiment of the present disclosure, the payment terminal monitoring device 120 may generate identifier information displayed on a map based on store information for each category of the store situation for each category. Since the identifier generated for each category of the store situation for each category is output through the user terminal 130, the manager may easily identify the store situation for every category. The payment terminal monitoring device 120 may generate the identifier information such that at least one of a shape, a size, and a color of the identifier varies depending on categories of the store situation for each category and at least one of a shape, a size, and a color of the identifier varies depending on the risk level of the store.

According to an exemplary embodiment of the present disclosure, the payment terminal monitoring device 120 may generate travel route information between at least two stores among a plurality of stores which are classified as a sales warning store and a store where the payment terminal is not driven. The sales warning store and the store where the payment terminal is not driven need to be managed by the manager and the manager may directly visit the store. In this case, when there is a plurality of sales warning stores and stores where the payment terminal is not driven, the payment terminal monitoring device 120 may generate the travel route information including an optimal route to visit the store by considering the location of the stores. The payment terminal monitoring device 120 sets a travel route using the store location information of the store information to set an optimal travel route by recognizing a maximum number of stores which can be visited for one day, in consideration of the distance between stores. For example, when inputs for an area of the store to be visited during a specific period (for example, one day or four hours), a type of store (a store with normal sales, a sales warning store, a store where the payment terminal is not driven, and a waiting store), and the number of stores desired to be visited are received, the payment terminal monitoring device 120 may generate information on an optimal travel route in consideration of the received inputs and the store information of each store.

In the case of a businessman who operates a store, an additional loan may be required during the operation of the store. For example, in the case of a restaurant, a large amount of various food materials is purchased so that a large amount of money is required to buy food materials. Therefore, most businessmen buy the food materials with funds through long-term or short-term loans. Therefore, the loan of the businessman may be periodically made so that the manager of the bank or the lender visits the store of the businessman and introduces a loan product to attract the customer. The payment terminal monitoring device 120 may identify the sales for each store through the payment information received from the payment terminal 110 of each store so that it is possible to calculate a store which is expected to use a next loan or an expected date based on the sales. Therefore, the payment terminal monitoring device 120 may additionally generate travel route information with respect to a store which is expected to use a loan or a store whose expected loan date comes up.

The payment terminal monitoring device 120 may transmit the sales status information, a store situation for each category, and information on the store risk level to the user terminal 130. Further, the payment terminal monitoring device 120 may transmit the generated identifier information and the travel route information to the user terminal 130. According to an exemplary embodiment of the present disclosure, the user terminal 130 may be a user terminal of a manager of the bank or the lender described above. Further, the user terminal 130 may be a user terminal of a self-employed person who operates the store or a user terminal of a manager (for example, a manager of a franchiser head office) which collectively manages the stores. Further, the user terminal 130 may include all kinds of wireless communication devices such as a smart phone, a smart pad, a tablet PC, a personal communication system (PCS), a global system for mobile communication (GSM), a personal digital cellular (PDC), a personal handyphone system (PHS), a personal digital assistant (PDA), an international mobile telecommunication (IMT)-2000, code division multiple access (CDMA)-2000, W-code division multiple access (W-CDMA), a wireless broadband internet (WiBro) terminal and wired communication devices such as a desktop computer and a smart TV.

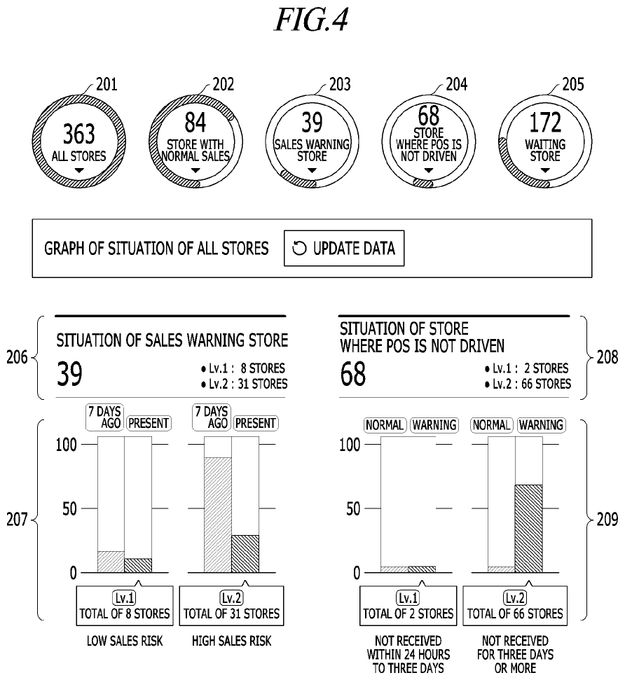

FIG. 3 is a view illustrating a configuration of a user terminal of a payment terminal monitoring system according to an exemplary embodiment of the present disclosure.

Referring to FIG. 3, the user terminal 130 may include a terminal communication unit 131 and an output unit 132. The terminal communication unit 131 may receive sales status information, a store situation for each category, information on a store risk level, identifier information, and travel route information. The output unit 132 may output the store situation for every category and the store risk level distinguished based on the payment information for each store, the store information, and the status information. Further, the output unit 132 may output sales status information, sales information for every menu, and menu management information. For example, the output unit 132 may output sales status information for every date, sales ranking information for every menu, menu change information, increased/decreased sales, and selling trends of main menu.

Further, the output unit 132 may output the store situation for each category and the store risk level through a display device included in the user terminal 130 or a separate display device connected to the user terminal 130. Further, the output unit 132 may output a travel route on the map based on the identifier information and the travel route information. Hereinafter, the output of the user terminal 130 will be described with reference to the drawings. According to an exemplary embodiment of the present disclosure, information displayed by the user terminal 130 may be implemented by an application or a program provided by the payment terminal monitoring device 120.

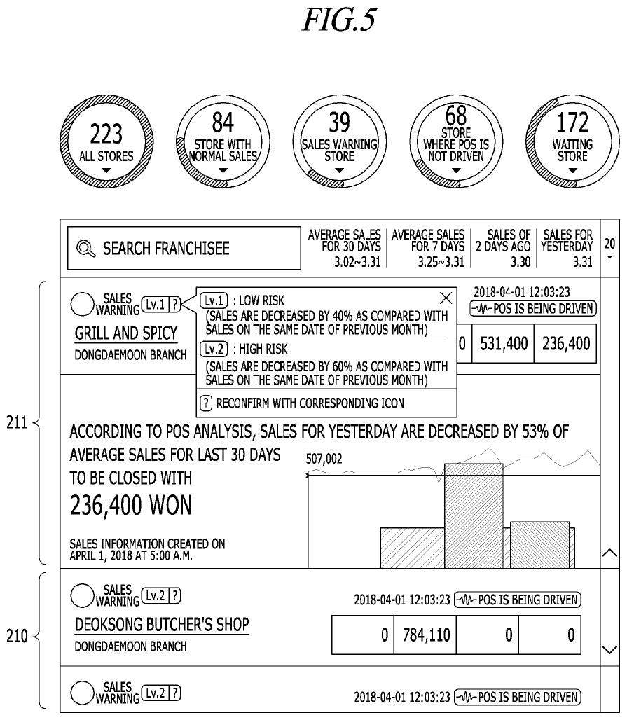

FIG. 4 is a view illustrating a store situation and a risk level for each category output on a user terminal of a payment terminal monitoring system according to an exemplary embodiment of the present disclosure.

Referring to FIG. 4, the output unit 132 may output categories for all stores 201, a store 202 with normal sales, a sales warning store 203, a store 204 where a payment terminal is not driven, and a waiting store 205 and the number of stores included in the category. Further, the output unit 132 may output the situation of the sales warning store and the number 206 of stores at every sales risk level or output the number of stores at every sales risk level in a diagram form 207. Further, the output unit 132 may output the situation of the store where the payment terminal is not driven and the number 208 of stores at every sales risk level or output the number of stores at every business risk level in a diagram form 209.

FIG. 5 is a view illustrating a situation of a sales warning store output on a user terminal of a payment terminal monitoring system according to an exemplary embodiment of the present disclosure.

Referring to FIG. 5, when the user terminal 130 receives a user input which selects a sales warning store among a plurality of categories, the output unit 132 may output a list 210 of identifiers (for example, a store name) of stores which are classified as a sales warning store. When a user clicks any one store in the list 210, a risk state level of the store and information 211 on a reduced sales amount may be output. For example, the reduced sales amount may include a percentage of an average of a recent reference date compared with the average of a past reference date and the reduced sales amount.

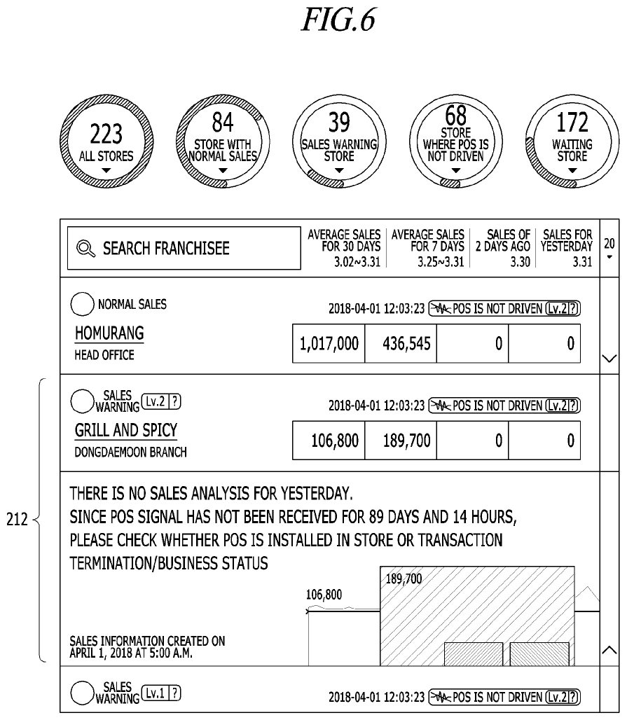

FIG. 6 is a view illustrating a situation of a store where a payment terminal is not driven output on a user terminal of a payment terminal monitoring system according to an exemplary embodiment of the present disclosure.

Referring to FIG. 6, when a user input which selects a store where the payment terminal is not driven among the plurality of categories is received, the output unit 132 may output a list of identifiers (for example, a store name) of a store which is classified as a store where the payment terminal is not driven. When a user clicks any one store in the list, information on an un-driven time of the payment terminal of the store may be output 212 and a guidance text guiding to check the payment terminal of the store may be output.

FIG. 7 is a view illustrating a situation of a waiting store output on a user terminal of a payment terminal monitoring system according to an exemplary embodiment of the present disclosure.

Referring to FIG. 7, when a user input which selects a waiting store among the plurality of categories is received, the output unit 132 may output a list 213 of identifiers (for example, a corporate registration number or a store name) of a store which is classified as a waiting store. When the user clicks any one store in the list, a processing situation 214 for every step of registering the store may be output. According to an exemplary embodiment of the present disclosure, the step of registration may include store registration, rate input, program installation, receipt collection, analysis waiting, and data analysis. As the processing situation 214 for every step of registration is provided, the manager may easily understand the situation of processes to be processed until a store subscribing to a service provided by the payment terminal monitoring device 120 quickly and smoothly receives the service.

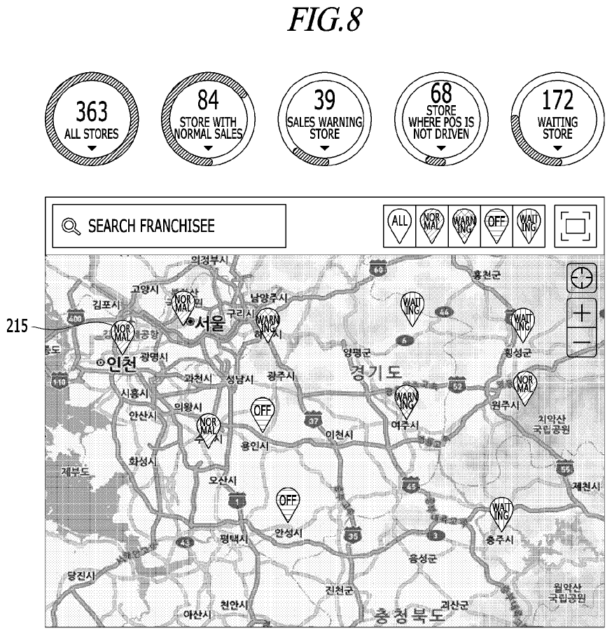

FIG. 8 is a view illustrating a map and an identifier output on a user terminal of a payment terminal monitoring system according to an exemplary embodiment of the present disclosure.

Referring to FIG. 8, the output unit 132 may output an identifier 215 for each category of the store situation for each category on a map based on the identifier information received from the payment terminal monitoring device 120. In the case of the identifier 215, at least one of a shape, a size, and a color of the identifier may vary depending on categories of the store situation for every category and at least one of a shape, a size, and a color of the identifier may vary depending on the risk level of the store. Further, the output unit 132 may output such that at least one of the shape, the size, and the color of the identifier varies depending on the risk level. Further, the output unit 132 may output a travel route between a sales warning store and a plurality of stores classified as a store where the payment terminal is not driven, on the map, based on the travel route information received from the payment terminal monitoring device 120.

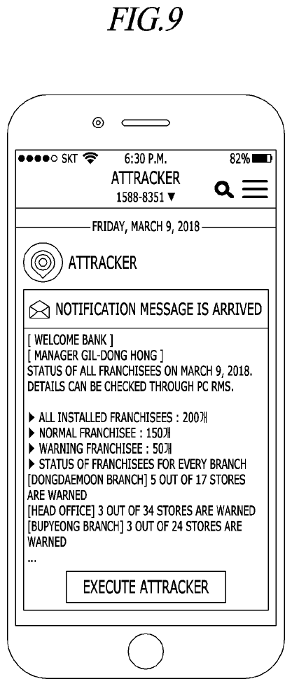

FIG. 9 is a view illustrating a message notifying a store situation for each category output on a user terminal of a payment terminal monitoring system according to an exemplary embodiment of the present disclosure.

Referring to FIG. 9, the payment terminal monitoring device 120 generates message information including the number of all stores managed by the manager, the number of stores with normal sales, the number of sales warning stores, and the number of stores where the payment terminal is not driven and transmits the message information to the terminal communication unit 131. Further, the message information may include a store situation for every area. For example, the message information may be generated to include information indicating that there are five sales warning stores among a total of 17 stores in an AA district, for every administrative district. The output unit 132 may output message information received from the payment terminal monitoring device 120. For example, the message may be output through an SNS or a messenger application installed in the user terminal 130. Therefore, the manager who uses the user terminal 130 may conveniently and simply identify the store situation information.

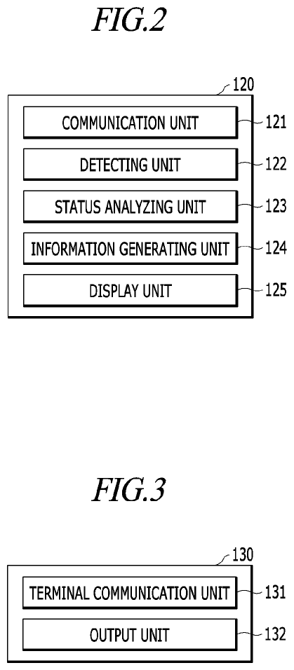

FIG. 2 is a view illustrating a configuration of a payment terminal monitoring device according to an exemplary embodiment of the present disclosure.

Referring to FIG. 2, the payment terminal monitoring device 120 may include a communication unit 121, a detecting unit 122, a situation analyzing unit 123, an information generating unit 124, and a display unit 125. The communication unit 121 may receive payment information generated in the payment terminal 110 for each store. The communication unit 121 may receive payment information from the plurality of payment terminals 110 through the network. The payment information may include a payment menu, a payment price, a payment time, and a payment terminal identifier.

The information generating unit 124 may generate sales status information for each store based on the payment information received from the payment terminal 110 and previously stored store information. For example, the store information may include at least one of a store identifier (franchisee ID), business hour information of the store, closing hour information, and store location information.

The detecting unit 122 may detect status information of the payment terminal 110 for each store. The status information may include, for example, a driving status or non-driving status of the payment terminal 110. The communication unit 121 may periodically transmit a payment terminal driving signal to the payment terminal 110 for each store. When the payment terminal driving signal is received, if the payment terminal 110 is being driven, the payment terminal 110 may transmit an answer signal to the communication unit 121. The detecting unit 122 may determine that the payment terminal 110 which transmits the answer signal is in a driving state and a store equipped with the payment terminal 110 is being operated. Further, when the payment information (or an answer signal) is not received from the store during the business hour of the store, the detecting unit 122 may detect the status information indicating that the payment terminal of the store is not driven, based on the business hour information and closing hour information of the store. Further, even though the payment information or the answer signal is not received from the payment terminal 110 of the store during the closing hour of the store or besides the business hour, the detecting unit 122 does not determine that the payment terminal 110 is not driven. However, when the payment information or the answer signal is not received during the business hour, the payment terminal monitoring device 120 may detect status information indicating that the payment terminal 110 of the store is not driven.

The situation analyzing unit 123 may distinguish the store situation for each category based on the payment information for each store, the store information, and the status information and determine the store risk level. The store situation for each category may include categories indicating “all stores”, “a store with normal sales”, “a sales warning store”, “a store where a payment terminal is not driven”, and “a waiting store.”

The communication unit 121 may transmit the sales status information, a store situation for each category, and information on the store risk level to the user terminal 130. In this case, the store risk level may include a risk level of the category of the sales warning store and the store where the payment terminal is not driven. For example, when the communication unit does not receive the payment information from the store during the business hour of the store, the detecting unit 122 may detect the status information indicating that the payment terminal of the store is not driven, based on the business hour information and closing hour information of the store.

The situation analyzing unit 123 may classify a store from which the payment information has never been received, among stores corresponding to previously stored store information, as a waiting store. The waiting store indicates a store from which the payment information has never been received, among stores corresponding to previously stored store information.

The display unit 125 may generate identifier information displayed on the map, based on the store information for each category of the store situation for each category. The communication unit 121 may transmit the identifier information to the user terminal 130. Further, the display unit 125 may generate the identifier information such that at least one of a shape, a size, and a color of the identifier varies depending on categories of the store situation for each category and at least one of a shape, a size, and a color of the identifier varies depending on the risk level of the store. Further, the display unit 125 may generate travel route information between at least two stores among a plurality of stores which are classified as a sales warning store and a store where the payment terminal is not driven and the communication unit 121 may transmit the travel route information to the user terminal 130.

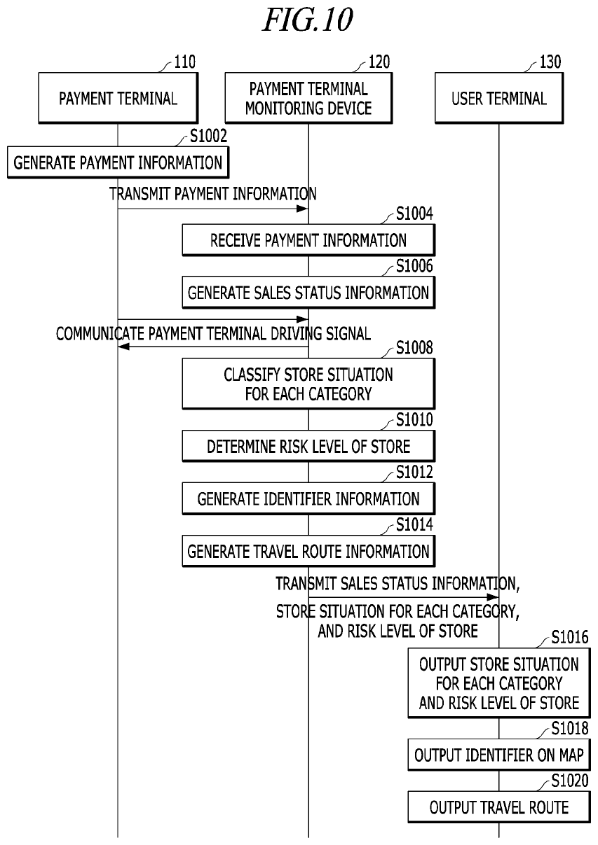

FIG. 10 is a flowchart illustrating a payment terminal monitoring method according to an exemplary embodiment of the present disclosure.

The payment terminal monitoring method according to the exemplary embodiment of the present disclosure illustrated in FIG. 10 may be performed by the above-described payment terminal monitoring system as illustrated in FIGS. 1 to 9. Therefore, even though omitted in the following description, the contents described for the payment terminal monitoring system with reference to FIGS. 1 to 9 may be applied to FIG. 10 in the same manner.

Referring to FIG. 10, in step S1002, the payment terminal 110 may generate payment information. The payment information may include a payment menu, a payment price, a payment time, and a payment terminal identifier. Further, the generated payment information may be transmitted to the payment terminal monitoring device 120. In step S1004, the payment terminal monitoring device 120 receives the payment information from the payment terminal 110 and in step S1006, generates sales status information for each store based on the payment information and previously stored store information. For example, the store information may include at least one of a store identifier (franchisee ID), business hour information of the store, closing hour information, and store location information.

In step S1008, the payment terminal monitoring device 120 detects status information of the each payment terminal for each store and classifies the store situation for each category based on the payment information for each store, the store information, and the status information. The status information may include a driving status or non-driving status of the payment terminal 110. The payment terminal monitoring device 120 may periodically transmit a payment terminal driving signal to the payment terminal 110 for each store. When the payment terminal driving signal is received from the payment terminal monitoring device 120, if the payment terminal 110 is being driven, the payment terminal 110 may transmit an answer signal to the payment terminal monitoring device 120. The payment terminal monitoring device 120 may determine that the payment terminal 110 which transmits the answer signal is in a driving state and a store equipped with the payment terminal 110 is being operated. Further, when the payment information (or an answer signal) is not received from the store during the business hour of the store, the detecting unit 122 may detect the status information indicating that the payment terminal of the store is not driven, based on the business hour information and closing hour information of the store. Further, the store situation for each category indicates a plurality of categories set to identify a business state of the store and stores belonging to every category. The store situation for every category may include categories indicating “all stores”, “a store with normal sales”, “a sales warning store”, “a store where a payment terminal is not driven”, and “a waiting store.” For example, a store from which the payment information has never been received, among stores corresponding to previously stored store information, may be classified as a waiting store.

In step S1010, the payment terminal monitoring device 120 may determine a store risk level for the category of the sales warning store and the store where the payment terminal is not driven. The payment terminal monitoring device 120 may determine a risk state step of the store depending on how much the difference between the average sales of the past reference date and the average sales of the recent business days is higher than the predetermined threshold value. Further, the payment terminal monitoring device 120 may determine a business risk level depending on a time during which the payment terminal 110 of the store is not driven. In step S1012, the payment terminal monitoring device 120 may generate identifier information displayed on a map based on store information for each category of the store situation for each category. In step S1014, the payment terminal monitoring device 120 may generate travel route information between the plurality of stores classified as the sales warning store and the store where the payment terminal is not driven.

The payment terminal monitoring device 120 may transmit the sales status information, a store situation for each category, and information on the store risk level to the user terminal. Further, the payment terminal monitoring device 120 may transmit the generated identifier information to the user terminal 130. Further, the payment terminal monitoring device 120 may transmit the generated travel route information to the user terminal 130.

In step S1016, the user terminal 130 may receive the sales status information, the store situation for each category, and information on the store risk level from the payment terminal monitoring device 120 and output the store situation for every category and the store risk level classified based on the payment information for each store, the store information, and the status information.

In step S1018, the user terminal 130 may output an identifier for multiple categories of the store situation on the map, based on the identifier information received from the payment terminal monitoring device 120.

Further, in step S1020, the user terminal 130 may output a travel route on the map based on the travel route information.

The payment terminal monitoring method according to the exemplary embodiment of the present disclosure may be implemented as program commands which may be executed by various computers to be recorded in a computer readable medium. The computer readable medium may include solely a program command, a data file, and a data structure or a combination thereof. The program command recorded in the medium may be specifically designed or constructed for the present invention or known to those skilled in the art of a computer software to be used. Examples of the computer readable recording medium include magnetic media such as a hard disk, a floppy disk, or a magnetic tape, optical media such as a CD-ROM or a DVD, magneto-optical media such as a floptical disk, and a hardware device which is specifically configured to store and execute the program command such as a ROM, a RAM, and a flash memory. Examples of the program command include not only a machine language code which is created by a compiler but also a high level language code which may be executed by a computer using an interpreter. The hardware device may operate as one or more software modules in order to perform the operation of the present invention and vice versa.

The above-description of the present disclosure is illustrative only and it is understood by those skilled in the art that the present disclosure may be easily modified to another specific type without changing the technical spirit or an essential feature of the present disclosure. Thus, it is to be appreciated that the embodiments described above are intended to be illustrative in every sense, and not restrictive. For example, each component which is described as a singular form may be divided to be implemented and similarly, components which are described as a divided form may be combined to be implemented.

The scope of the present disclosure is represented by the claims to be described below rather than the detailed description, and it is to be interpreted that the meaning and scope of the claims and all the changes or modified forms derived from the equivalents thereof come within the scope of the present disclosure.

What is claimed is:

1. A payment terminal monitoring device for stores, comprising:
a communication unit which receives payment information generated in a payment terminal for each store;
a detecting unit which detects status information of the payment terminal for each store; and
a situation analyzing unit which classifies a store situation for each category, based on the payment information for each store, store information, and the status information.

2. The payment terminal monitoring device according to claim 1, wherein the situation analyzing unit determines a store risk level based on the payment information for each store, store information, and the status information.

3. The payment terminal monitoring device according to claim 2, further comprising:
an information generating unit which generates sales status information for each store, based on the payment information and the store information,
wherein the payment information includes a payment menu, a payment price, a payment time, and a payment terminal identifier and the store information includes at least one of business hour information of the store, closing hour information, and store location information.

4. The payment terminal monitoring device according to claim 3, wherein the communication unit transmits the sales status information, the store situation for each category, and information on the store risk level to a user terminal.

5. The payment terminal monitoring device according to claim 2, wherein the store situation for each category includes categories indicating all stores, a store with normal sales, a sales warning store, a store where a payment terminal is not driven, and a waiting store.

6. The payment terminal monitoring device according to claim 5, wherein the store risk level includes a risk level of a category of the sales warning store and the store where a payment terminal is not driven and
when the communication unit does not receive the payment information from the store during the business hour of the store, the detecting unit detects the status information indicating that the payment terminal of the store is not driven, based on the business hour information and closing hour information of the store.

7. The payment terminal monitoring device according to claim 4, wherein the situation analyzing unit classifies a store from which payment information has never received from a store corresponding to previously stored store information as a waiting store.

8. The payment terminal monitoring device according to claim 4, further comprising:
a display unit which generates identifier information displayed on a map, based on the store information for each category of the store situation for each category,
wherein the communication unit transmits the identifier information to the user terminal.

9. The payment terminal monitoring device according to claim 8, wherein the display unit generates the identifier information such that at least one of a shape, a size, and a color of the identifier varies depending on categories of the store situation for each category and at least one of a shape, a size, and a color of the identifier varies depending on the risk level of the store.

10. The payment terminal monitoring device according to claim 8, wherein the display unit generates travel route information between at least two stores among a plurality of stores classified as sales warning stores or a store where a payment terminal is not driven and the communication unit transmits the travel route information to the user terminal.

11. A user terminal which monitors a payment terminal of a store, the user terminal comprising:
a terminal communication unit which receives payment information generated by a payment terminal for each store and status information of the payment terminal for each store, from a payment terminal monitoring device; and
an output unit which outputs a store situation for each category classified based on the payment information for each store, store information, and the status information and a store risk level.

12. The user terminal according to claim 11, wherein the terminal communication unit receives sales status information for each store generated based on the payment information and the store information from the payment terminal monitoring device and the payment information includes a payment menu, a payment price, a payment time, and a payment terminal identifier and the store information includes at least one of business hour information of the store, closing hour information, and store location information.

13. The user terminal according to claim 12, wherein the terminal communication unit receives information on the store situation for each category and the store risk level from the payment terminal monitoring device.

14. The user terminal according to claim 11, wherein the store situation for each category includes categories indicating all stores, a store with normal sales, a sales warning store, a store where a payment terminal is not driven, and a waiting store.

15. The user terminal according to claim 14, wherein the store risk level includes a risk level of a category of the sales warning store and the store where a payment terminal is not driven.

16. The user terminal according to claim 15, wherein the terminal communication unit receives identifier information displayed on a map, based on the store information for each category of the store situation for each category from the payment terminal monitoring device.

17. The user terminal according to claim 16, wherein in the identifier information, at least one of a shape, a size, and a color of the identifier varies depending on categories of the store situation for each category and at least one of a shape, a size, and a color of the identifier varies depending on the risk level of the store.

18. The user terminal according to claim 16, wherein the output unit outputs an identifier displayed on the map based on the identifier information.

19. The user terminal according to claim 16, wherein the terminal communication unit receives travel route information between at least two stores among a plurality of stores which are classified as a sales warning store and a store where a payment terminal is not driven, from the payment terminal monitoring device.

20. A payment terminal monitoring method of a store, comprising:
receiving payment information generated in a payment terminal for each store;
detecting status information of the payment terminal for each store; and
classifying a store situation for each category based on the payment information for each store, store information, and the status information and determining a store risk level.

21. A computer readable recording medium in which a program allowing a computer to execute the method according to claim 20 is recorded.
